(19) United States
(12) Patent Application Publication
(10) Pub. No.: US 2007/0046954 A1
(43) Pub. Date: Mar. 1, 2007

(54) Method of verifying consistent measurement between a plurality of CD metrology tools

(75) Inventors: Hugo Augustinus Joseph Cramer, Eindhoven (NL); Erik Johannes Maria Van Brederode, Best (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/210,113

(22) Filed: Aug. 24, 2005

(51) Int. Cl. G01B 11/14

(52) U.S. Cl. 356/625

(57) ABSTRACT

A method of matching CD-SEM's to ensure consistent measurements over an installed base of SEM's is disclosed by measuring with each of a plurality of scanning electron microscopes the feature size of resist features in at least two positions on the substrate such that field-to-field variations, and reticle and exposure tool non-uniformities are efficiently suppressed in the matching result.

### 1. FIELD

The present invention relates generally to methods of correlating measurements using a plurality of CD-Metrology tools.

### 2. BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging by means of an imaging projection system, onto a layer of radiation-sensitive material (resist) provided on the substrate. A beam of radiation is used to illuminate the reticle, and the patterned beam of radiation (after traversing the reticle) exposes radiation-sensitive material on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Microchip fabrication involves the control of tolerances of a space between features or a width of a feature, and/or a distance between elements of a feature such as, for example, two edges of a feature. In particular, the control of dimension tolerance of the smallest of such spaces, width and/or distances permitted in the fabrication of the device or IC layer is of importance. Said smallest space and/or smallest width is commonly referred to as the critical dimension (“CD”).

Lithographic apparatus are highly sophisticated and require qualification and monitoring to check and maintain that they meet the stringent operating criteria promised to the customer. Lithographic apparatus qualification and monitoring is partly executed outside of machines using a CD-Metrology tool (e.g. a scanning electron microscope (SEM)) to measure the control of the critical dimension and/or other spaces, width and distances between features. To this end lithographic apparatus machine manufacturers and users of lithographic apparatus machines may have several CD-Metrology tools which are used to test specimen substrates imaged by lithographic apparatus. The tests include measuring the critical dimension CD of different types of features (multiple lines, isolated lines, contact holes, aberration test features etc.) It is convenient that the CD results do not depend on the specific CD-Metrology tool used and so CD-Metrology tool matching is performed to ensure that CD-Metrology tools are measuring the size of the same sized features to within an allowed tolerance. For example, for the 100 nm node the total tolerance, i.e., the tolerance of the lithographic apparatus and proving measurement, is typically 8 nm, for 65 nm it is about 4 nm, the tolerances for specific test features, such as the difference between an isolated line and one of multiple lines are even smaller. This requires that the SEM matching is performed with a tolerance that is typically ⅕^{th} of the total tolerance.

### SUMMARY

According to an aspect of the invention, there is provided a method of verifying consistent measurement between a plurality of CD-Metrology tools, including, providing a substrate having a photosensitive layer which has been irradiated in a plurality of fields with a pre-determined feature of a pre-determined feature size, first measuring, with a first of said plurality of CD-Metrology tools, said feature size in a first area within a first field on said substrate; second measuring, with a second of said plurality of CD-Metrology tools, said feature size in a second area of a second field, the position of the second area relative to the second field being the same as the relative position of the first area to the first field, and comparing results of said first and second measuring to determine whether consistent measurement between said plurality of CD-Metrology tools exists.

According to another aspect of the invention, there is provided a method of verifying consistent measurement between a plurality of CD-Metrology tools, including, providing a substrate having a photosensitive layer which has been irradiated in a plurality of fields with a pre-determined feature of a pre-determined feature size, measuring, with each of said plurality of CD-Metrology tools, said feature size in at least two areas in each of two fields on said substrate, and comparing results of said measuring to determine whether consistent measurement between said plurality of second measuring, with a second of said plurality of CD-Metrology tools, said feature size in a second area of a second field, the position of the second area relative to the second field being the same as the relative position of the first area to the first field, and comparing results of said first and second measuring to determine whether consistent measurement between said plurality of CD-Metrology tools exists.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 illustrates, in plan, the top surface of a substrate;

FIG. 2 illustrates the measurement technique of the present invention; and

FIG. 3 illustrates a further embodiment of the invention.

### DETAILED DESCRIPTION

So called CD-SEMs which are scanning electron microscopes (SEM) used for critical dimension (CD) qualification of lithographic apparatus must be matched against one another to ensure consistent measurements over an installed base of CD-SEMs. Matching verification involves the comparison of measurements of the same set and size of features by all CD-SEMs of the installed base. For example, a multiple lines feature can be measured for a plurality of different pitches (critical dimension). The invention is not limited to any particular type of feature or any particular type of feature size and can be used to evaluate the CD-SEMs for any size and type of feature.

Other types of CD-Metrology tools, particularly scatterometers, are also used for CD qualification and the present invention also applies to them. The invention is described below in relation to CD-SEMs.

Because the SEM electron beam interacts with resist (photosensitive layer) on the surface of the substrate, and this interaction causes so-called “shrinking”, resist features (i.e. features irradiated onto the resist by a beam of radiation and developed) cannot be measured multiple times in a straightforward manner. By contrast, wafers with patterned Si features (i.e. where the substrate has been processed after exposing and developing the photoresist layer, following exposure by a patterned beam of radiation, in order to transfer the features to the substrate) do not suffer from this problem.

During lithographic apparatus qualification and monitoring, it is preferred to measure the critical dimension of features imaged and developed in resist because a SEM interacts differently with a patterned Si substrate than with resist. Thus, using a patterned Si substrate for matching could result in an incorrect offset and the matching might need to be carried out at different operating conditions of the CD-SEM than used for the actual measurements. However, given that the SEM electron beam interacts with the resist repeated measurements of the same resist features will give different results, therefore a substrate with resist features cannot be used straightforwardly to match multiple CD-SEMs. One way to avoid the shrinkage is to measure corresponding features exposed in multiple fields on the substrate. This way, however, the variation in CD's of corresponding features in multiple fields over the wafer that arise from the exposure and in particular processing (i.e. non-uniform post exposure bake) can have an impact on the outcome of the matching verification.

It has been found that the method described below can reduce the impact of variation due to processing variations and reticle pattern errors as well as exposure variations by at least a factor of 5 over the prior art. Thus, by using the method it is possible to perform CD-SEM matching i.e. verifying consistent measurement between a plurality of scanning electron microscopes, using a substrate which has a photo-sensitive layer which has been exposed, in a plurality of fields, with a patterned beam, whereby the pattern comprises a pre-determined feature of a pre-determined feature size.

The method will be described in more detail with reference to FIGS. 1-3.

FIG. 1 illustrates a substrate W on which a photo resist has been exposed in a plurality of fields 10. In the example of FIG. 1 the substrate has been exposed, using the same reticle with just one feature having one dimension at a size corresponding to the critical dimension in each field so that the patterns in each of the exposed fields have the same feature and feature size. However, this is not necessarily the case and a single wafer could be irradiated in different fields with different features and/or features with different sizes. It is also possible for each field to contain one or more features of one or more sizes. Clearly in CD-SEM matching it is preferable to match SEMs for different types of features as well as for different sizes of features.

If multiple SEM's were to measure the feature size in all fields, there would be a large spread of results due to shrinkage of resist. If each SEM measures adjacent areas in the same fields, which have been designed to be of the same CD, there could be large spread of results due to variations in the fabrication process of the reticle or mask and/or systematic non-uniformities in the exposure step. If each SEM measures corresponding areas in different fields on the substrate (corresponding means in the same relative location in the field, hence exposed using the same portion of the reticle or mask), there could be a spread of results due to variation of the processing (coat, bake and/or develop steps) over the wafer.

The variations in measured feature sizes due to variations in the resist profiles can be suppressed.

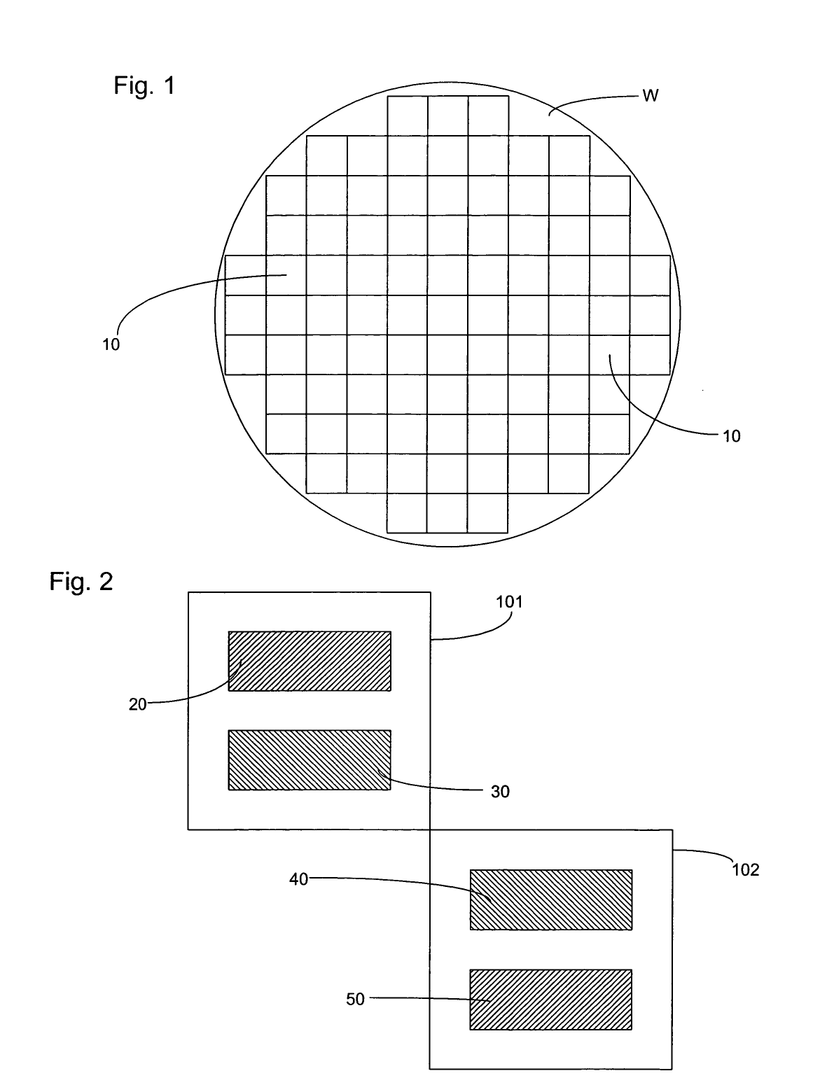

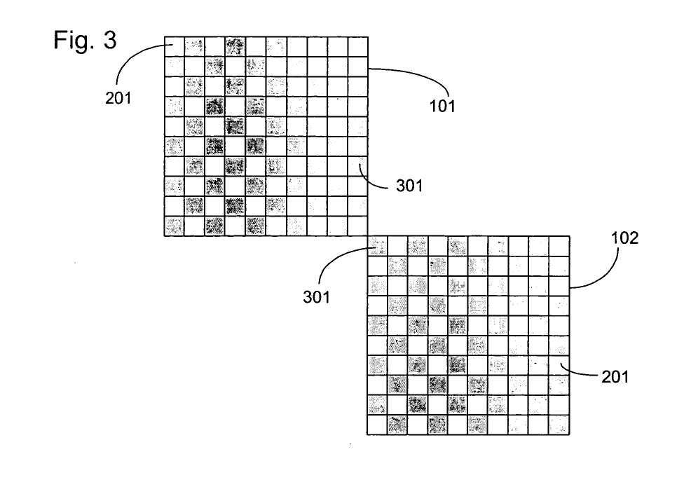

The following description will be based on the method being used to match two SEMs. However, the same principles can be used for any number of SEMs which are being matched. FIG. 2 illustrates the most simple example in which areas 20, 40 which are measured by a first SEM are illustrated with right to left downward sloping lines whereas areas 30, 50 measured by a second SEM are indicated with left to right downward sloping lines. It can be seen that in a first field 101 the first SEM measures the feature size in a first area which is located at the upper part of the field 101 as illustrated. In the second field 102, the second SEM measures the feature size in an equivalent area 40 to the area which is measured by the first SEM in the first field. The second SEM also measures the feature size in the first field 101 in an area 30 in the lower half of the field and which is different to the area 20 measured by the first SEM. In the second field 102, the first SEM measures the feature size in an area 50 which is equivalent to the area 30 which is measured by the second SEM in the first field 101.

Although in FIG. 2 it is shown that the first areas 20, 40 and second areas 30, 50 are both in exactly the same relative position within a field, this is not necessarily the case and the areas may be positioned slightly differently. Interlacing of the areas can be used to suppress within field variations as each of the SEMs will measure areas which are subject to the same variations.

This pattern can be expanded and in FIG. 3 the whole of the fields 101, 102 are illustrated as being split into an imaginary grid having shaded and unshaded areas. The unshaded areas 201 of the grid measured are by the first SEM and the shaded areas 301 are measured by the second SEM. As can be seen, the pattern is fully interlaced and those areas measured by the first SEM in the first field 101 are measured by the second SEM in the second field 102. Therefore, each of the plurality of scanning electron microscopes measures the feature size in at least two positions of each of at least two fields. The first of the plurality of scanning electron microscopes measures the feature size in a first area 201 of a first field 101 of the two fields and a second of the plurality of electron microscopes measures the feature size in an equivalent area 301 to the first area but in a second field of two fields and vice versa. As a result, the averaged values of these measurements for each of the plurality of SEM's have exactly the same contribution of the systematic reticle and exposure system variations, and these variations will no longer impact the matching result. Also the effect of field-to-field variations on the matching results are effectively suppressed since each of the plurality of SEMs measures the same number of features in each field, with almost the same location in each field.

A plurality of features may be measured at each position and a single substrate W may be provided with features of only one type in all fields 10 or may be provided with different fields of different types of feature and/or size of feature. In the illustrated embodiment the two fields 101, 102 are shown as being adjacent but this is not necessarily the case and they may be spaced apart. If more than two fields are measured field-to-field variations can also be suppressed.

The matching result is the difference between the average readings of the CD-SEMs for the same type of features/spaces/widths.

It has been found experimentally by self-matching at the 80 nm node (comparing the results of one SEM to a second set of measurements with the same SEM) that the new procedure results in consistent measurements with as low as 0.36 nm 3σ. The procedure in which features in two fields are measured with SEM 1 and features in two adjacent fields measured with SEM 2 has residues in the self-matching as high as 2.0 nm 3σ.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other fields of lithography.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method of verifying consistent measurement between a plurality of CD-Metrology tools, comprising:
providing a substrate having a photosensitive layer which has been irradiated in a plurality of fields with a pre-determined feature of a pre-determined feature size;
first measuring, with a first of said plurality of CD-Metrology tools, said feature size in a first area within a first field on said substrate;
second measuring, with a second of said plurality of CD-Metrology tools, said feature size in a second area of a second field, the position of the second area relative to the second field being the same as the relative position of the first area to the first field; and
comparing results of said first and second measuring to determine whether consistent measurement between said plurality of CD-Metrology tools exists.

2. The method of claim 1, wherein said first CD-Metrology tool measures said feature size in a third area within said second field, wherein said third area is in a different position relative to said second field than the relative position of the first area to the first field.

3. The method of claim 2, wherein said second CD-Metrology tool measures said feature size in said first field in fourth area, wherein the fourth area is in a position relative to said first field the same as the relative position of said third area to said second field.

4. The method of claim 3, wherein said first and second CD-Metrology tools each measure said feature size at a plurality of areas within said first and second fields, said areas measured in said first field by said first CD-Metrology tool being in positions relative to said first field the same as the relative position of areas measured by said second CD-Metrology tool to said second field.

5. The method of claim 4, wherein said areas are interlaced.

6. The method of claim 1, wherein said two fields are adjacent.

7. The method of claim 1, wherein said two fields are spaced apart.

8. The method of claim 1, wherein a plurality of features are measured in each area.

9. The method of claim 1, wherein said plurality of CD-Metrology tools are a plurality of scanning electron microscopes or a plurality of scatterometers.

10. A method of verifying consistent measurement between a plurality of CD-Metrology tools, comprising:
providing a substrate having a photosensitive layer which has been irradiated in a plurality of fields with a pre-determined feature of a pre-determined feature size;
measuring, with each of said plurality of CD-Metrology tools, said feature size in at least two areas in each of two fields on said substrate; and
comparing results of said measuring to determine whether consistent measurement between said plurality of CD-Metrology tools exists.

11. The method of claim 10, wherein a first of said plurality of CD-Metrology tools measures said feature size in a first area of a first field of said two fields and a second of said plurality of CD-Metrology tools measures said feature size in an area in the same relative position to its field as said first area but in a second field of said two fields.

12. The method of claim 11, wherein a first of said plurality of CD-Metrology tools measures said feature size in a second area of a first field of said two fields and a second of said plurality of CD-Metrology tools measures said feature size in an area in the same relative position to its field as said second area but in a second field of said two fields.

13. The method of claim 10, wherein said at least two areas at which successive ones of said plurality of CD-Metrology tools measure are interlaced.

14. The method of claim 10, wherein a first of said plurality of CD-Metrology tools measures said feature size in a first area of said at least two areas in a first of said two fields and a second of said plurality of CD-Metrology tools measures said feature size in a second of said two fields at a location within the field which is located at the same or approximately the same relative position to the second field as the first area is to the first field.
